(19) United States
(12) Patent Application Publication
(10) Pub. No.: US 2010/0070988 A1
(43) Pub. Date: Mar. 18, 2010

(54) SYSTEMS AND METHODS FOR MEASURING AN AUDIENCE

(76) Inventors: Yossef Gerard Cohen, Rosh Haayin (IL); Eliahu Elson, Ramat Gan (IL)

Correspondence Address: The Law Office of Michael E. Kondoudis, 888 16th Street, N.W., Suite 800, Washington, DC, 20006, US

(21) Appl. No.: 12/625,080

(22) Filed: Nov. 24, 2009

Related U.S. Application Data
(63) Continuation-in-part of application No. PCT/IL2008/000703, filed on May 25, 2008.

(30) Foreign Application Priority Data
May 24, 2007 (IL) 183386

(51) Int. Cl. H04H 60/33; G06K 9/00; H04N 5/335

(52) U.S. Cl. 725/10; 382/117; 348/308; 348/E05.091

(57) ABSTRACT

Systems and methods for measuring an audience by: directing a light source in the direction of the audience; detecting reflections of the light source from the audience by a light detector in order to form an image representing the audience eyes; and analyzing the image received on the light detector to identify and count the number of eyes on the image. Preferably, the analyzed information is communicated to a remote facility. The light source can be in the visible spectrum, infrared (IR) spectrum or even ultraviolet (UV) spectrum. The reflected light from the retina or cornea is then captured by a light detector.

### CROSS-REFERENCE TO RELATED APPLICATIONS

This application is a continuation-in-part of International Patent Application PCT/IL2008/000703 filed on May 25, 2008, which, in turn, claimed the benefit of Israeli Patent Application No. 183386, filed May 24, 2007. The subject matter contained in the related applications and patents is specifically incorporated herein by reference.

### FIELD OF THE INVENTION

The present invention relates to a system and method for measuring an audience, and in particular for measuring an audience by identifying open eyes.

### BACKGROUND OF THE INVENTION

Measuring an audience precisely is a question of great economic importance especially in areas such as television programs, advertisement (across all media), movie films, outdoor advertisements, malls and shops etc. For example, the more people watch a television program, the higher the price the content provider can charge the program broadcaster, and the higher the price the broadcaster can charge for advertisement with that television program. The more people visit a mall or a shopping center, the higher the price the mall operator can charge for store rent. The number of people determined to watch a television program will also determine if the program is continued or should be replaced.

Television ratings are typically performed by measuring a representative sample. In the United States, for example, Nielsen Media Research samples more than 5,000 voluntary households, containing over 13,000 people, out of the about 99 million households with TVs in the U.S. (all information concerning Nielsen Media Research here and below is provided by Nielsen on their United States Internet site: http://www.nielsenmedia.com).

It is not only important to measure what program the television is displaying but also who and how many people (or “eyeballs” in the terms of the advertisement industry) are watching the program at a specific moment. Current people measuring devices also referred to as “peoplemeter's”, use a voluntary system where each participating person has to actively signal when he's starting and finishing watching a program. Nielsen Media Research uses a dedicated device which each rating participant has to press when he starts and finishes watching television (a remote control is also available).

Another method used by Nielsen Media Research is to ask people to maintain diaries where they note what each person is watching in 15-minute periods. The diaries are then mailed back to Nielsen Media Research every quarter for analysis.

Yet another method used in the art for measuring television audiences is conducting telephone polls relying on people's good memory and faith.

Naturally, all these voluntary people measuring systems have numerous inconveniences and limitations. A person may forget to press the button at times or a person may not press the button when leaving the room for a short break for example when going to the kitchen or the toilette at a commercial break. A person might expressively avoid pressing the button in order to not be identified as watching certain content, for example adult content. In addition, a person may be in the same room as the television set but actually not watching it and instead be talking to another person, talking on the phone, reading, being asleep etc. The voluntary peoplemeter cannot be used in places like sports bars where a large and irregular audience may be watching specific events.

It is thus very desirable to develop a solution for accurately measuring the number of people watching a program in an automatic and independent way without requiring any act or action from these people.

General methods of counting people are known in the art, for example, methods based on image processing algorithms. US Patent Application 2006/0062429 suggests a method for detecting motion in the image and comparing two images take at different subsequent times. Applying an image processing algorithm determines if at least one shape represents a person. US Patent Application 2006/0200841 suggests a method of identifying people in an image by identifying human-like shapes in a captured image. These types of methods image processing have several disadvantages: they are expensive to implement and requires substantial processing power and also do not provide a response to the question whether the person detected is actually watching a program is simply engaged in another activity.

Eye tracking applications are also known, in particular for use with handicapped people. These applications, which also use expensive signal processing hardware and software, typically require the person to sit in a distance of up to 60 centimeters of the screen, and are only suited for tracking the eyes of a single person.

Traditionally, the television set has been used mainly for watching television programs received over the air, via cable or satellite. With the convergence of the Internet and the television, more and more solutions are proposed for using the television as a mean for accessing both television programs and content through the Internet, sometimes simultaneously. For example, an advertisement might demonstrate a product with the possibility of purchasing the product via an Internet connection from the same screen. Another convergence scenario is when an Internet connection provides more data or an advertisement related to the content of the television program watched, for example, while watching a sports event the viewer may request more information about the track record of a team or a player or receive advertisements for sports-related material.

Currently, advertisement in the Internet is typically measured per user click or exposure and always assumes that a single user is watching the computer screen. If Internet content and advertisement are watched on television in the living room, it would be highly desirable to estimate how many people are watching the television set in order to price the advertisement accordingly. The person who is supposed to watch an advertisement on television may be sleeping, talking on the phone, reading a newspaper, eating or not in front of the TV at all.

Regarding outdoors advertisements, currently the only relevant information collected is at best how many people walk or pass by these outdoor advertisements. When a person walks in front of an advertisement it does not mean that person has actually noticed it. Even when the person's eye glances at the advertisement, it still does not mean the person actually read or captured the advertisement. There is a minimal required time that an eye needs to look at a message in order to assure that the advertisement was “consciously seen” or captured. It would be highly desirable if the real number of eyes watching the outdoor advertisement was counted and consequently the advertiser could automatically measure or monitor the exposure ratings of an advertisement so to judge its real effectiveness and the optimal time to change it.

Photographs of people taken with a camera using flash often exhibit a phenomenon called red-eye. The effect is caused by reflection of the camera flash from the back of the eye. Typically the pupil of the eye develops a greater or lesser degree of red color. However, other colors can occur (such as gold-eye) and the effect may be sufficiently intense to eliminate all detail in the eye so that the pupil and iris cannot be distinguished, forming a single red blob. The likelihood of red-eye is increased when the eye is dark-adapted and the pupil is wide open, which represents precisely the low light situation that requires flash illumination. In such a case, the pupil does not have time to close before a reflection occurs from the back of the eye. The effect is further increased for inexpensive or compact cameras having a flash mounted close to the axis of the lens, which increases the likelihood that reflected light will enter the lens. This has the unfortunate effect that the most pronounced red-eye can occur when the eye is small compared to the size of the image, and so is hardest to correct. Further impediments to correction result, for instance, from reflections caused by contact lenses.

### SUMMARY OF THE INVENTION

The present invention relates to a system and method for measuring an audience, and in particular to measuring an audience watching a television program or present in a physical location.

In another aspect, the present invention relates also to a method of interactively sending advertisement depending on the measured audience.

The invention thus relates to a metering system for measuring an audience, the system comprising:
(i) one or more light sources directed in the direction of the audience;
(ii) one or more light detectors for detecting reflections of the one or more light sources from the audience to form an image representing eyes in the audience;
(iii) a scanning module to direct said one or more light sources and said one or more light detectors at narrow portions of said audience at a time;
(iv) a scanning controller for driving said scanning module; and
(v) a processing unit for analyzing the images received on the one or more light detectors to form an image representing said audience eyes and to identify and count the number of eyes on the image.

In one embodiment of the present invention, the system further contains a communications line for communicating the analyzed information to a remote facility. The communication lines can be wired and/or wireless and use any communication method known in the art.

The definition of “image” as referred to herein should be interpreted in a large sense and also includes a signal received from a single light detector or from an array of light detectors.

The first component of the system is a light source directed in the direction of the audience to be measured. The light source can be in the visible spectrum, infrared (IR) spectrum or even ultraviolet (UV) spectrum. The light source sends out a light beam that is reflected by each eye in the audience.

The reflected light from the retina or cornea is captured by a light detector. The light detector can be a matrix of sensors such as a Charge Coupled Device (CCD) or Complementary Metal Oxide Semiconductor (CMOS). The light detection technology can include silicon, Gallium Arsenide or any other known technology. Alternatively, the light detector can be a line sensor or a single pixel sensor of any type known in the art, for example, a photodiode or similar sensor. The light detector is sensitive to the wavelength of the light source. An optional spectral filter may be installed in front of the light detector in order to enhance the captured signal quality and filter unnecessary background light not related to measuring the number of eyes.

The light detector can use any optical lens (single or compound) known in the art in order to optimize the light detection process.

The invention exploits a phenomenon known as “redeye”, which often occurs when taking pictures of people in dark environments using a compact camera with a flash. For small camera frames the flash is located too close to the camera's optical axis, causing flash light to reflect from a subject's retina back onto the image sensor. This frequently results in pictures of people with red eyes. While current applications concerning the redeye effect concentrate their efforts in disabling this effect, the present invention focuses its efforts to enhance and emphasize the redeye effect, for example by choosing the optimal wavelength according to the transmission of the optical components of the eye and the reflection of the retina, by optimizing with the spectral sensitivity of the device detector. The invention thus identifies and counts the number of open eyes in the captured image. Analyzed information can then be sent to a remote facility via any available communication line such as the Internet, the telephone line (both wired and wireless) or any private or public network.

The term “redeye” as referred herein should be interpreted as the phenomenon of a reflection from the retina/cornea. The phenomenon does not mean that the eyes return a red color or any other color, but merely that it returns a reflection that can be identified. For example, when working with infrared illumination, the reflection from the retina/cornea is captured as a bright spot, without any particular color.

In addition, the invention can use the reflected light from the cornea which appears as bright spots on the iris. The invention can also identify eyes by detecting reflected light from the cornea. Alternatively, reflections from both the retina and the cornea can be used to detect eyes.

The system then analyzes each image to match pairs of eyes, so that each pair is counted like a single person. According to predefined system parameters, depending upon the commercial and technical implementation of the invention, the system communicates the analyzed data to a remote facility for further processing.

The system of the invention does not track the position of each eye, but rather detects and counts eyes in each captured image. The system can detect and count eyes from a distance of about 40 centimeters up to tens of meters.

A separate device of the invention can be installed as an independent component, integrated into a set-top box or even integrated into the television set. The device of the invention may also be used to measure audience anywhere, for example, students in a classroom, people entering a mall, people waiting in line for a service etc.

Television advertisements can be more accurately priced according to the number of people actually watching them. In addition, the proposed system can be used for rating the advertisements themselves since the metering can be continuous and communicated online.

The proposed system can also be used to measure how many people were exposed to an outdoor advertisement and actually looked at its direction as well as the number of people who actually looked enough time at the advertisement so that they could capture its message.

The present invention can also be implemented as a method for counting an audience, said method comprising the steps of:

(i) directing one or more light sources in the direction of said audience;

(ii) detecting reflections of said one or more light sources by one or more light detectors in order to form an image representing eyes in said audience;

(iii) scanning the audience by directing said one or more light sources and said one or more light detectors at narrow portions of said audience at a time; and

(iv) analyzing images received on said one or more light detectors to form an image representing said audience eyes and to identify and count the number of eyes on said image.

In another aspect, the present invention relates to an advertising method for sending commercial advertisements to an audience in front of a television set, the method comprising the steps of: (i) detecting the presence of at least one viewer in front of said television set; and (ii) sending an advertisement to the television set only when the at least one viewer is detected. It is thus possible to guarantee to an advertiser that its advertisement has actually been seen by an audience, as opposed to current television advertisements that are placed in before, after or in the middle of a program, though the audience watching the program may leave the room or simply change channels at the commercial break.

The advertising method of the invention can use any available method or methods in order to detect the presence of an audience. Thus it can use the detection methods of the invention: redeye detector and skin reflection detection or use any other known detection method such as human shape analysis, voice detection, and/or volume detection.

### BRIEF DESCRIPTION OF THE DRAWINGS

FIG. 1 illustrates a basic setup of an audience measuring device of the invention including a light source directed at the direction of a person of the audience, and an electrooptic sensor receiving the reflected light from the open eyes of the audience.

FIG. 2 illustrates the spectral transmission of the different components of the human eye.

FIG. 3 is a block diagram of an embodiment of a metering system of the invention integrated into a single unit.

FIG. 4 is block diagram of an embodiment of a metering system of the invention wherein the sensing unit is separated from the processing and communication unit.

FIG. 5 is block diagram of an embodiment of a metering system of the invention wherein two separate sensing units communicate with a single processing and communication unit.

FIG. 6 is a fluorescence peaks table with some examples of values illustrating how to improve the signal quality in relation to background light, as demonstrated also in FIG. 7.

FIG. 7 is a graph illustrating the usage of a fluorescence peaks technique. In this example it can be seen that the light source emits light at wavelength 292 nm, and a narrow band filter that transmits only wavelength 366 nm in front of the detection sensor blocks the background at different wavelengths than the filter including stray reflections from the source light itself, collecting only the light reflected from the eye and thus improving the signal to background.

FIG. 8 illustrates an embodiment wherein the light source and detection means are aligned in a collinear line of sight with the aid of a beam splitter (B.S.)

FIG. 9 illustrates an embodiment wherein an optical filter is added to the setup shown in FIG. 1.

FIGS. 10A and 10B illustrates an embodiment using a wide field-of-view. Wide field of views are necessary when the audience consists of a group of people.

FIG. 11 is an embodiment similar to that of FIG. 1 wherein the system of the invention comprises a scanning module.

FIG. 12 is an embodiment similar to that shown in FIG. 11, wherein the scanning is performed only in one dimension (horizontal).

FIG. 13 is an embodiment of the invention similar to FIG. 3 further comprising a scanning module.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a method for measuring an audience, and a system and device for implementing the method. The invention thus provides a method for measuring an audience, the method comprising the steps of:
(i) directing a light source in the direction of the audience;
(ii) detecting reflections of the light source from the audience by a light detector in order to form an image representing the audience eyes; and
(iii) analyzing the image received on the light detector to identify and count the number of eyes on the image.

Optionally, the method can comprise a further step of communicating the analyzed information of (iii) to a remote facility. The remote facility can further process the received data, and can also decide on the appropriate action to take based on the information received.

The term “audience” as referred to herein should be interpreted in a broad sense to encompass, a viewing public, a participating public, passive public, animals, fish and the like.

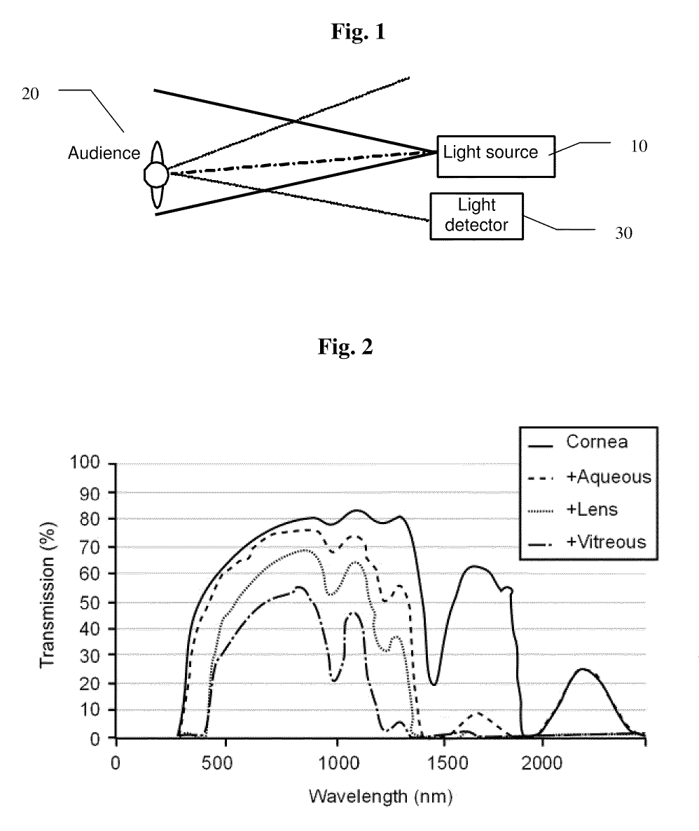

FIG. 1 illustrates the basic elements of the system of the invention: a light source 10 directed in the direction of the audience 20, and a light detector 30 detecting the reflections coming back from the open eyes of the audience 20.

The first component is a light source 10 directed in the direction of the audience 20 to be measured. The light source 10 can be in ultraviolet spectrum (200-400 nm), in the visible spectrum (400-700 nm (nanometers)) or in the near infrared (NIR) spectrum (respectively 700-3000 nm). This spectrum range, or part of it, is sometimes also referred to as SWIR (Short Wave Infrared).

A light detector 30 is used to capture the reflected light from the audience 20. The light detector 30 can be a Charge Coupled Device (CCD) camera that is a device with light-sensitive photo cells which is used to create bitmap images. Alternatively other types of camera can also be used such as a Complementary Metal Oxide Semiconductor (CMOS) camera, any other digital camera, an analog camera, a camera including an image intensifier coupled to the camera's matrix (intensified camera). The light detector 30 can also be a single sensor or a line camera, or a single detector or a matrix of several detectors (2×2, 4×4, 10×10, 1000×1000 for example, or with different aspect ratio) or four quarter detectors or position sensitive detector. Naturally, the camera includes adequate optical components, familiar to any person skilled in the art, in order to focus the light beams into the electrooptic sensor.

A distinct advantage of a camera compared to a single sensor is that a camera allows distinguishing between different objects in the field of view (FOV) while with a single dimensional sensor each object in the field of view along the line of sight can contribute to the signal, but may not be distinguishable on its own.

Another example of a light detector is a photodiode or an avalanche photodiode.

Alternatively, it is also possible for the invention to use any available natural or artificial light such as the sun light or any indoor artificial lighting.

The invention exploits the “redeye” effect in photography. Redeye (picture of people with red eyes) happens when the light of the flash occurs too fast for the iris of the eye to close the pupil. The flash light is focused by the lens of the eye onto the blood-vessels-rich retina at the back of the eye and the reflection of the illuminated retina is again collected by the camera resulting in a red appearance of the eye on the photo. The “redeye” phenomenon can also occur with animals although the color of the eyes may be different than red. Therefore, it is better to use the near IR wavelength since it does not disturb the audience 20 and the reflections from the retina are better.

The measured spectral reflection from the retina of the human eye for the spectral ranges between 400 nm and 1500 nm is known in the art. As known in the art, the reflection local maxima are received at wavelength of 920 nm, 1100 nm and 1300 nm.

FIG. 2 shows spectral contribution of each optical component of the eye. As can be easily seen there are wavelength with better transmission than others. For example, the upper graph shows the transmission through the cornea. In order to know the total reflection back from the eye, it is necessary to calculate both the transmission of the different components of the eye in combination with the reflection from the retina (not shown) as can be found in the literature.

Typical background light that is present in the field of view of the sensor comes from the sun in exterior ambient and from fluorescent or incandescent lamps in interior ambient. This ambient light background is a drawback when trying to discriminate the red eye reflection from the background in an image, because the light levels of the background are high compared to the level reflected from the eye and simple algorithms like histogram threshold or high percentage threshold are not able to distinguish between these two factors. Using short pulses of the light source 10 together with synchronized time gate of the detector can improve the signal to background ratio. For example, the light source 10 can operate in a short pulse and the light detector 30 is then only exposed at exactly the same time and interval as the light pulse so only that integration time of the background is collected. On the other hand, the reflected signal is fully exploited.

The method of the invention analyzes the resulting captured image or images and counts the number of eyes. A pair of adjacent eyes can be associated and counted as a single person. The number of people identified in an image is sent to a processing location every predetermined period of time using available communication lines such as the Internet, telephone networks (wired or wireless), data networks, cable network or any other available communication mean.

It is important for the light source 10 to be located as close as possible to the light detector 30 so that the reflected light going back from the eye to the light source 10 can be captured by the light detector 30.

Upon reading this application, a person skilled in the art will immediately recognize alternative methods for recognizing and counting eyes, and all these alternatives and variations are deemed to be within the scope of the present invention. For example, one can use a second light source 10 that is purposely far from the light detector 30, such that the picture taken when using the second light source 10 will not have the “redeye” effect. By subtracting the two images, an important portion of the background can be eliminated.

Similarly to the “redeye” principle, the invention produces much better results using a light source 10 with a near IR wavelength, as explained before. The resulting eyes in the picture will not be colored in red, but will be nevertheless identifiable by the light detector 30 in a similar manner. Thus the term “light” as used herein refers not only to electromagnetic waves in the visible range of the spectrum but rather to any wave, beam, radiation, electromagnetic wave, light beam, light wave and any other similar term.

The eyes on the captured image can be identified by detecting reflected light from the retina and/or cornea.

Naturally, the spectral range of the light source 10 and the spectral range of the light detector 30 need to match. For example, silicon-based light detectors 30 such as CCD and CMOS cameras are adapted to detect light beams with a wavelength up to 1100 nm. If for example, a light source 10 above 1100 nm is used—a wavelength that is still considered safe for the human eye—then the light detector 30 needs to be based on different technology than silicon, for example, detectors based on the Gallium arsenide (GaAs).

It is important to consider the safety aspects of the light source 10 (such as laser pointers, incandescent bulbs, halogen bulbs, visible or IR lasers, Light Emitting Diode (LED), transistor LED, transistor Laser) and the intensity of the emitted light in order not to cause any potential damage to the eyes. Solid state laser or a laser diode are popular light sources 10 and are implemented today in a variety of devices such as laser pointers. The intensity of the light source 10 such as a solid laser or a laser diode needs to conform to the safety standards such as the American standard ANSI Z136.1 or any similar standard.

The light source 10 can operate in a continuous manner or only emit periodically in pulses. Depending on the light source 10, it can be operated either continuously, in pulses or both. A continuous light source 10 can be made to emit in pulses by using a chopper. A more flexible method is to operate a LED via a wave generator, a signal generator or a specific electronic integrated circuit and thus control the pulses in a flexible and random way. A chopper for example, can be used to create pulses with a constant duty cycle and a constant time cycle. Changing the speed of the wheel can change the time cycle and width of the pulse, but it cannot change each individual pulse. Changing the duty cycle requires changing the wheel to a wheel with different opening spaces.

In a light source 10 such as a LED or lasers, the pulses can be controlled by a signal generator to determine as needed the kind of signal required at each moment. This flexibility can thus be used to influence the momentary intensity of the light source 10 to control the amount of light receive by the light detector 30 in one hand, and meet safety regulations on the other hand.

Using the redeye effect allows to use simple signal-processing algorithms in order to identify eyes in the picture by separating the light returned from the eye from the light returned by the background. For example, when using visible light, the eyes will be colored in red, and thus a primary search for red zones will immediately reduce the number of potential candidates (eyes).

Similarly, using non-visible light the light returned by the eyes will be stronger than the light returned from the background (such as the face), and thus the eyes will be easily detectible. In some instances, the intensity of the light returned from the face might be very similar to that returned from the eyes, especially if the distance from the light source 10 is very short. In these situations, it is necessary to apply additional signal processing algorithms known in the art, and/or combine these algorithms with the use of a second light source 10, not co-lineated with the sensor, as described above. For short ranges the cornea reflection may be useful and thus be exploited for counting eyes.

For more accurate results, further signal-processing refinements are necessary in order to isolate the eyes from the rest of the captured picture, since other spots in the picture may also reflect high intensity light returns. For example, background filtering algorithms known in the art can be used by the invention in order to isolate the eyes from its surroundings. The surroundings may be the light reflection of the background from the light source 10, or it may be an external ambient light illuminating the background.

In one embodiment of the present invention, the light source 10 has a spectrally narrow bandwidth or includes a spectral filter. Examples of spectral filters include but are not limited to: a band pass filter, band stop filter, interference filter, short wave filter, long wave filter, Acousto-optic Tunable filter (AOTF) filter or any mechanical, electrical or electro physical mechanism that can cause a spectral modification of the outgoing light

Another example of a preprocessing background filtering method that can be used by the invention is a differential operation of the light source 10. The object is for the light detector 30 to capture an image once with the light source 10 activated and once without the light source 10. By subtracting the two images, an important portion of the background can be eliminated.

The quality of the received signal by the light detector 30 can be increased by increasing the exposure time of the light detector 30. If for example, in a scene where the background is low and the refresh rate for counting people watching television is set up to be one second, the light detector 30 (camera) can be set up with an exposure time of 500 milliseconds (compared to the 20 milliseconds exposure time of a standard camera), thus increasing the quality of the received signal.

Yet another example of background filtering method is by operating a light source 10 with a narrow spectrum width, that is a light source 10 emitting light within a restricted range of wavelengths, say 30 nm around the 900 nm wavelength. These selected values (chosen here as an example only and can be replaced by other values) offer the advantage that since blood vessels in the retina absorb little light above 600 nm, more of such light is reflected and thus captured by the light detector 30. It is known that the human eye sees light better in the center of the photopic range that is around 550 nm, thus the human eye absorbs more light in the 550 nm range. Above the 600 nm range, the eye is less sensitive and thus absorbs less light. In order to take advantage of the narrow spectrum light source 10, it is essential that the light detector 30 filter will be substantially similar to the light source 10 spectrum.

Another signal-processing technique that can be used by the invention is spectral subtraction. Two images are captured each with a light source 10 in a different wavelength range. For an instance, if two images are captured with light sources 10 of 900 nm and 700 nm respectively. Since the hemoglobin (Hb) in the blood absorbs more light in 900 nm than in 700 nm, and the absorption of melanin pigment of the face is substantially similar at those wavelengths, then again subtracting the two images will help identify the eyes. Since the images are not captured in the dark, it may be needed to filter the background light by a spectral filter such that each time a light source 10 is activated the optical sensor is preceded by an optical filter according to the emitted wavelength of the light source 10.

Different processing methods can be combined to enhance the results of the captured images; these methods may be based on different modes of operation of the light sources 10 and of the light detectors 30. Both spectral subtraction and temporal subtraction for each spectrum can be operated. For example, a first image is captured within spectral bandwidth no. 1 (for example using an Acousto-optic Tunable filter (AOTF)) and a subsequent image is captured at spectral bandwidth no. 2 (by tuning the AOTF to a different bandwidth) simultaneously operating the light source 10 that also match the spectral bandwidth no 2.

A similar but yet different configuration can be performed by using an additional light source 10 that matches also the second bandwidth in the above example, and then taking two additional images with and without each of the light sources 10. Then for each bandwidth, one subtracts the image that was captured without activating the light source 10 from the image captured when the light source 10 was activated. Thus since the response of the eye to each of the spectral bandwidths is different, the difference between these two subtracted images will enhance the reflected light coming from the retina decreasing the light reflected from the surroundings (face and etc.). As a result, a simple threshold or other simple image processing algorithm can be used to finalize the detection of the audience 20 presence. The bandwidths example explicitly referenced above are only for the presentation of the concept and other combinations may be used, and also only part of the procedures explained here may be applied. It is also possible to use a plurality of bandwidths (more than two) with similar techniques.

In one embodiment of the present invention, the contrast between the eye and its background is enhanced by using a polarized light source 10 and/or adding a polarizer before the optical sensor in order to improve the signal-to-background ratio (especially where the cornea reflection is used). In yet another embodiment of the present invention, one or more light detectors 30 include a polarizer which is in the same orientation as the polarizer of one or more light sources 10 used.

It is also possible for one or more light detectors 30 to operate in a plurality of exposure times. A light detector 30 with variable exposure time can be helpful in calibrating and adjusting the system in different ambient light environments. It can also be useful to use one or more light sources 10 that operate in pulses of different pulse width in order to calibrate the system for good identification results without causing discomfort to the audience 20 according to the ambient external light level.

The techniques described above are examples of techniques used in order to get a better image, where the reflection from the eyes is emphasized compared to the background. Many image processing algorithms known in the art can be used in order to detect and count the number of eyes in each image. These algorithms include but are not limited to threshold discrimination, convolutions, convolutions with different kernel types, blob finding, morphological algorithms, contrast enhancing etc.

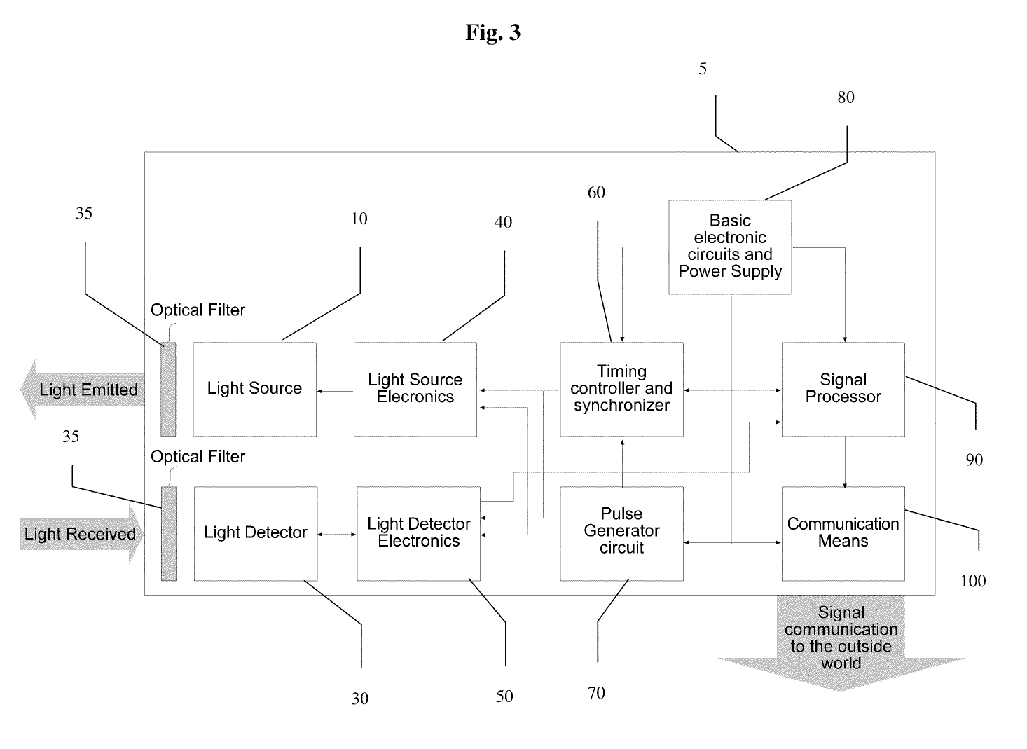

FIG. 3 is a block diagram of an embodiment of a metering system of the invention integrated into a single metering device 5. The light source 10, which may optionally include an optical filter 35, is driven by light source electronics 40 providing the necessary current for the corresponding light as a continuous or pulsed light. The light source electronics 40 is operated according to the signals received from the timing and controller synchronizer 60. The main “clock” for the proper operation of the timing controller is provided by the pulse generator circuit 70. Both the timing controller and the pulse generator are initialized from the signal processor 90 that uploads a code and defines the operational parameters of the device such as frame rate, exposure time, gain, filter type etc. The signal processing unit includes non volatile memory for code storing while the device is in an “off” state. The light reflected from the audience 20 is received by the light detector or detectors 30, optionally comprising an optical filter 35, that are controlled by the light detector electronics 50. The light detector electronics 50 also receive the current signal from the light detector 30 and amplify the signal before transmission to the signal processor 90. The signal is also digitized by the light detector electronics 50 when the light detector 30 provides an analog signal.

The signal processor 90 analyzes the received signal in order to detect the eye reflections from the scene background and count the number of eye pairs in the scene. In one embodiment, the number of people in the audience 20 is transmitted through communications lines 100 to a remote location or facility. The basic electronic circuits and power supply 80 provide all the voltages needed for the operation of the metering device 5. The power supply 80 can use electricity from either an external source or from internal batteries.

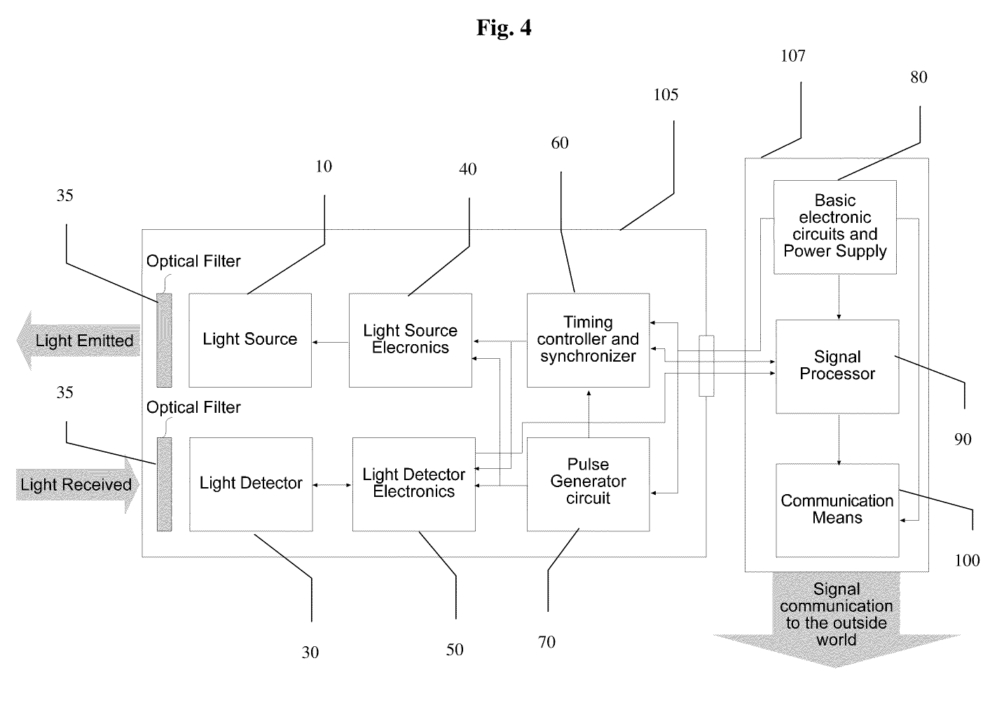

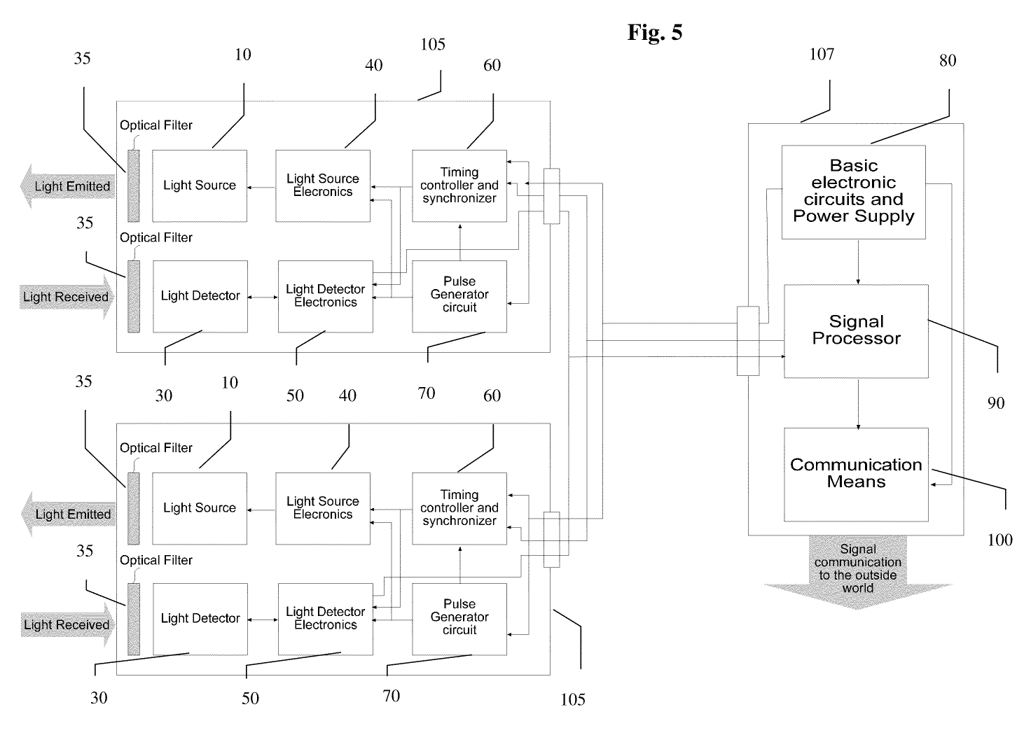

In another embodiment of the present invention, a metering system is constructed by two or more units. FIG. 4 shows a configuration of the system made of a separate sensing unit 105 communicating with a separate processing and communication unit 107. It is also possible for two (or more) sensing units 105 to communicate with a single processing and communication unit 107, as shown in FIG. 5.

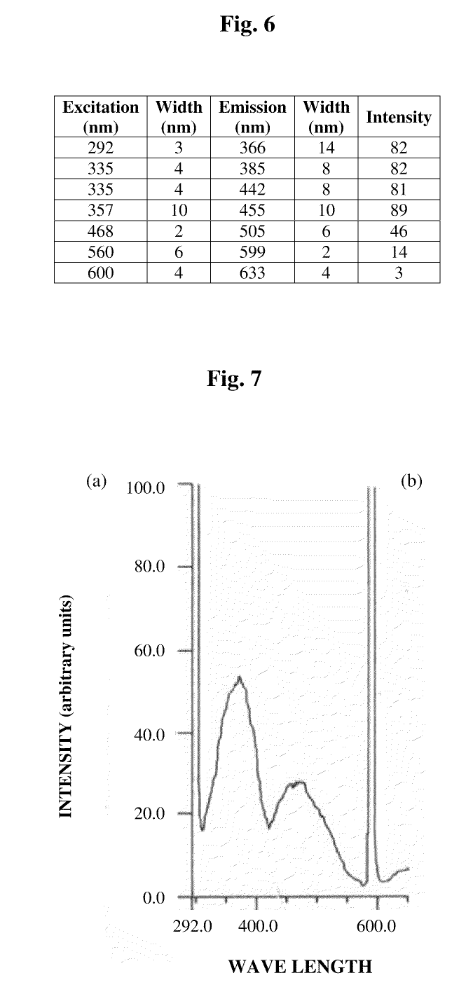

In yet another embodiment of the present invention, a fluorescence technique is used to improve the signal-to-noise ratio. FIG. 6 shows a fluorescence peaks table wherein the light source's 10 excitation is in one wavelength while the emission from the retina back to the light detector 30 is in another wavelength, so that the light source 10 emits in one wavelength and the light detector 30 will capture another wavelength. This helps eliminate the background noise from the emitted light source 10. A drawback of this method is that in many cases the intensity of the fluorescence peaks is not strong enough, and thus the captured signal is not of good quality in order to detect eyes. However, if in such a case it is possible to use a signal integration method, the resulting signal may be of adequate quality since the background is of a different wavelength, and processed by an appropriate optical filter 35.

UV Fluorescence—the preferred values for UV fluorescence are between 200 nm and 400 nm. The light source 10 uses a single wavelength between 200 nm and 400 nm, and the returned light from the blood vessels is of a higher wavelength due to the fluorescence effect. When using a light source 10 in the UV spectral range special care should be taken in order to keep safety conditions and this range should be used to applications where the exposure is confined to limited time, since the influence of this range to the eye safety is accumulative.

Return from the Retina—When calculating the transmission through the ocular components together with the reflection from the retina, as can be easily found in the literature based on in-vivo and in-vitro experiments performed on human and animal eyes, one concludes that the locally optimized spectrum ranges are 850-920 nm and 1050-1150 nm, and around 1300 nm. Alternative ranges that can be used by the invention include but are not limited to: 200 nm to 1600 nm, 700 nm to 940 nm, 1050 nm to 1150 nm, or 1300 nm to 1450 nm. Generally, the return from the retina is valid and operational from 300 nm to 1400 nm.

Return from the Cornea—the valid spectrum is between 300-2500. In 1450 nm there is better reflection performance

FIG. 7 shows an example of the fluorescence technique where the light source 10 is emitted with a wavelength of 292 nm and the light detector 30 captures higher wave lengths such as 370 nm, 470 nm or 600 nm or all these values together. These values are brought for illustration purposes and other known values, or values discovered in the future, can be used in the invention. Another example of fluorescence technique values not mentioned in FIG. 6 is excitation by a light source 10 at 787 nm and emission/reflection back from the eye at about 815 nm.

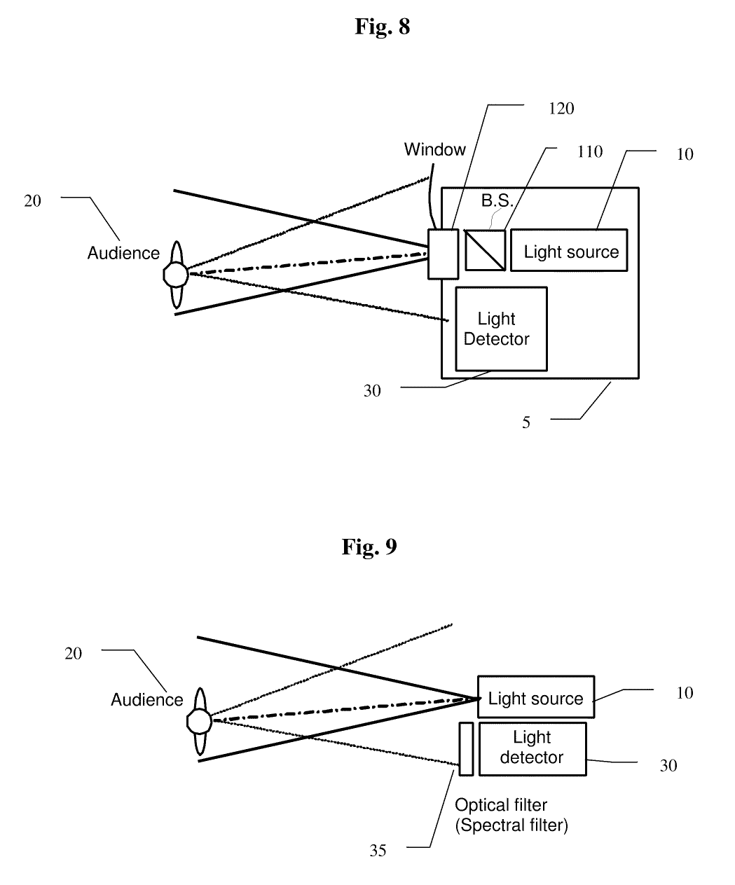

FIG. 8 illustrates an embodiment wherein the light source 10 and light detector 30 are aligned in a collinear line of sight with the aid of a beam splitter (B.S.) 110, thus improving the signal to noise and signal to background ratios, since the reflection is directed in an optimal way to the light detector 30. The invention can use any beam splitter know in the art such as a polarizing beam splitter, dichroic beam splitter etc. The beam splitter 110 is typically placed between the light source 10 and an optional protective window 120.

FIG. 9 illustrates an embodiment wherein an optical filter 35 (such as a spectral filter) is added to the setup shown in FIG. 1 before the light detector 30. The light source 10 used is a spectrally narrow light source 10. The use of an optical filter 35 such as a spectral filter discriminates unwanted background radiation that is present in the field of view. In addition, unwanted background radiation can also be eliminated by a narrow time light source which is synchronized with the light detector 30 exposure time. Both unwanted background radiation elimination methods can be used separately or combined together for better discrimination results. Examples of spectral filters include but are not limited to: a band pass filter, band stop filter, interference filter, short wave filter, long wave filter, AOTF filter or any mechanical, electrical or electro physical mechanism that can cause a spectral modification of the incoming light.

In another embodiment of the present invention, the wavelength between the light source 10 and the light detector 30 are made to correspond and the spectral filter of the light detector 30 is of a similar, narrower or greater wavelength than the spectral filter of the light source 10 in such a way that optimal performance is achieved.

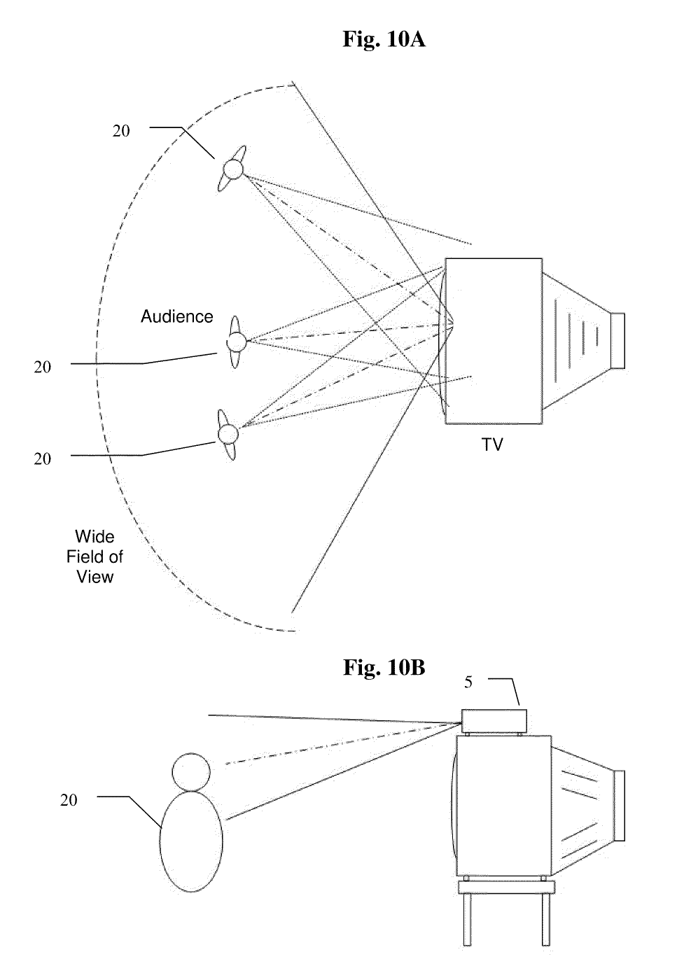

FIGS. 10A and 10B illustrate an embodiment using a wide field-of-view. FIG. 10A shows a top view an example where the audience 20 contains more than one person in front of the TV set. The system of the invention is adapted to illuminate the present audience 20 members and detect the reflections from each one of them.

FIG. 10B shows a side view of the wide field of view configuration. In this example, a metering device 5 of the invention appears as a separate box, or it could also be a part of a set-top box which is placed on top of the TV set. The metering system may also be integrated into the TV itself or on its panel.

Another way of using a single light detector 30 and still forming a two-dimensional image of the reflected light coming from the audience 20 is by transmitting a narrow-divergence light beam from the light source 10 and receiving the reflected light by a single light detector 30 with a narrow field of view corresponding to the divergence of the light source 10. The light is transmitted and received in such a way that the transmitted beam and the received light are scanned over the audience 20, for example, in a raster mode, so a two-dimensional image is built from the reflected light.

The limitations mentioned before regarding a single light detector 30 are valid when the single light detector 30 and emitted light source 10 are static. They do not refer to instances comprising scanning transmission and collection of light.

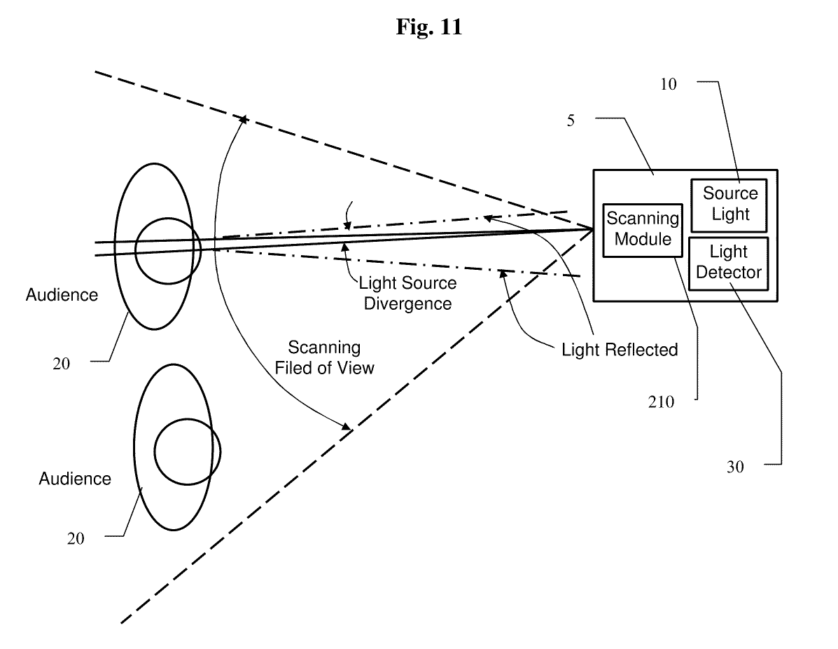

FIG. 11 illustrates a configuration similar to that shown in FIG. 1 further comprising a scanning module 210. The embodiment consists of a light source 10, a light detector 30 and a scanning module 210, all together incorporated into a single metering device 5. A light source 10 emits a narrow light beam divergence directed towards the audience 20 and the light reflected from the audience 20 and from the surroundings is collected by the light detector 30. The instantaneous field of view of the light detector 30 collects light within a cone whose base is the same area illuminated by light source 10. The scanning module 210 scan the mutual cone of light emitted by the light source 10 and of received the light of the light detector 30 in such a way that both move together over the field of regard. In this way, once all the received reflections from each instantaneous field of view are collected, they can be joined together into an image similar to the image formed in the example of FIG. 1. The image built then reflects the image of the field of regard that includes the reflections of the different people in the audience 20 that are present in the field of regard. FIG. 11 shows an arc marked as scanning field of view. This scanning field of view represents the top view of the field of regard, and the scanning in this example is horizontal. In order to complete the collection of the reflected light from the whole field of regard a scanning of the vertical field of view is also required.

The scanning is performed with the help of the scanning module 210 that are controlled by a scanning controller (not shown).

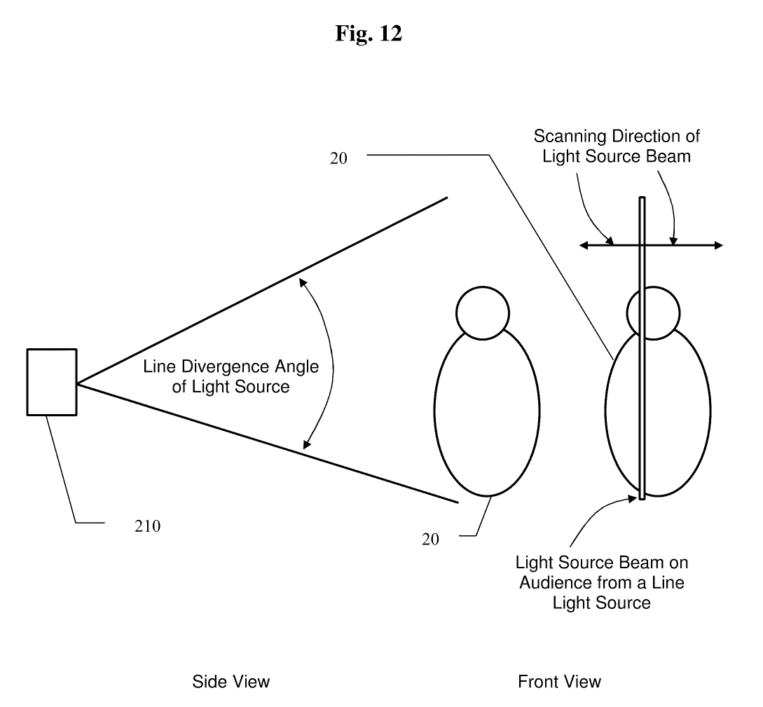

FIG. 12 is side view showing a scanning module 210 scanning a light beam coming from light source 10 (not shown) which is directed to the audience 20.

The line divergence angle of the light source 10 is shown as a span of vertical rays. In this example, the light beam coming from the light source 10 consists of a cone of rays with a rectangular profile, as shown in the right side part of FIG. 12.

The right side of the FIG. 12 shows a front view if the audience 20. In this example, the light beam is a beam with a very narrow rectangular shape. This rectangle covers all the vertical area of the audience 20 and the narrow part is scanned horizontally as shown by the arrows.

Since the light beam is a line then in order to form a two-dimensional image, only scanning in one dimension is required.

This narrow beam moves from left to right and back in order to cover the whole field of regard of the audience 20.

In this example, the light detector 30 should be an array of detectors arranged in a vertical one dimensional line, so they can detect with the help of optical lenses or cylindrical optics the reflected light from the audience 20. Similarly to the example of FIG. 11, once the line beam completes the scanning from left to right the two-dimensional image of the audience 20 can be built.

Since the scanning allows building up a two-dimensional image of the audience 20, all other mentioned capabilities of an array of detectors, can also be achieved by scanning, for example, measuring the PD (Pupillary Distance). The build up of a two dimensional image is not essential, since it is possible for each angle position of the scanning angle to detect the returned light from the eye. Then, it is possible to define from the angular position where the detected eyes are located, thus deducting whether a person with open eyes is present. In this way, the signal processing may be simplified and a storage memory for the two dimensional image in not required.

An additional advantage of a scanning method is from the safety point of view, since the light beam is not static and constantly moves across the different parts of the field of regard (the field of regard can be determined as the field of view of a corresponding field of view of a two dimensional array). As a result, since the energy density should be the same for a static or scanning light beam, then in the scanning method the exposure of the eye per unit time is lower than in a static mode.

Scanning further presents some additional advantages including but are not limited to: the audience can be located closer to the light sources without endagering the audience eyes; the intensity of the light sources (i.e. LED'S) may be much lower; the heat dissipation of the light sources is lower; the validation of the eyes detected is easier since in a narrow field of view the number of candidate eyes is maximum one to two pairs; the intensity applied during scanning can be varied and adapted according to the environment to be scanned unlike in a single capture where the intensity has to be maximized to the farthest distance to be captured; the uniformity of the light source is better in the narrow FOV than in the large FOV.

A disadvantage of the scanning method is that a scanning module 210 must be added to the module in order to perform the scanning. The scanning module 210 must also operate in a synchronized way if different scanning modules 210 are used for the light source 10 and for the light detector 30. The synchronization can be avoided when combining the line of sight of the light source 10 and the light detector 30 field of view with a beam splitter 110 as shown in FIG. 8. In that case, a mutual scanning module 210 is used for the scanning operated on both light emitted and light received.

The scanning module 210 can be, for example, a mirror with motors that control the moving of this mirror in two orthogonal angles, it can be done by using a Radio Frequency (RF) controlled acousto-optic deflection device, by using two wedges and rotating them separately and similar devices, or by any other method that is used in the art in order to deflect a light beam and thus enabling scanning of the light beam.

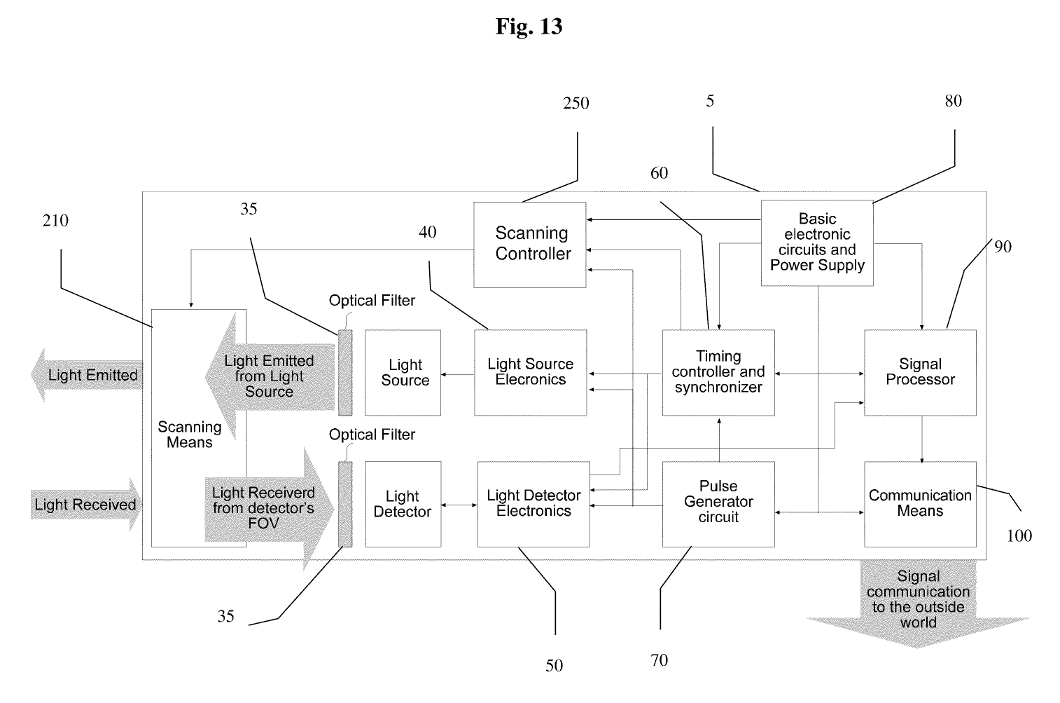

When using a scanning method, then the embodiments shown in FIGS. 3, 4 and 5 should be slightly modified so a scanning sub-module is added, for example, as shown in FIG. 13. In addition, a scanning controller 250 (scanning electronics or control unit) for driving the scanning module 210 should be added and this control box should be managed according to the outputs from the image processing box and the signals generated by signal generator should be provided also to that control electronics so the building of the two dimensional image should be done correctly.

Another advantage of using the scanning method is when employing wavelengths that are not compatible with silicon detectors. A cost effective alternative to using silicon two-dimensional arrays of detectors, is by using a single light detector 30 of GaAs family and exploiting the method of scanning synchronously the beam from the light source 10 together with the instantaneous field of view of the single GaAs light detector 30. Wherever a light GaAs detector 30 is mentioned, this is done as an example and other detectors may be used that are also able to detect wavelengths that silicon detectors are not able to detect or the detection is done by the silicon detectors with low efficiency.

A further advantage of the scanning method is that when a very large field of view is required, then two-dimensional arrays may be limited by the size and or resolution, while by using the scanning method a module, device or system can be designed to match each special field of view and resolution as well.

Once an image is formed with a scanning method or system, it can be exploited as any other image described herein. For example, if the mentioned formation of the image needs to be done at different wavelengths in one embodiment, then several light sources 10 may be used and these light sources 10 should be combined together in the metering device 5, as well as several single light detectors 30 may be used each of them with a corresponding spectral filter.

In one embodiment, shown as a non-limiting example, the scanning system comprises a light detector 30 such as a camera, a light source 10, a scanning module 210, a scanning controller 250 and a processing unit.

The scanning module 210 can comprise a mechanical bracket, a scanning motor, one or more light sources 10, one or more light detectors 30, and a scanning driver. Typically, the mechanical bracket moves the light source(s) 10 and light detector(s) 30. The scanning controller 250 comprises an electronic driver for the motor and an electronic synchronization driver. The scanning controller 250 times the movement and operation of the one or more light sources 10, one or more light detectors 30.

The light detector 30 may be a simple board camera preferably optimized to detect in the NIR spectrum, where the illumination will not disturb the audience 20. The camera 30 comprises optical lens and a spectral filter 35. The optical lens should be adapted according to the illumination divergence so the illuminated area is seen by the field of view (FOV) of the camera 30. The camera 30 FOV shall be defined small enough so the detection can be done but also large enough so the scanning can be effective and the scanning time shall be not prohibitive. For example, if the camera 30 sensor is in a ⅓″ format (i.e. 6.4 mm×4.8 mm) then using a lens with 25 mm focal length then the camera 30 FOV in the lateral orientation shall be approximately 14 deg while in elevation the FOV is approximately 11 deg. A different option is to rotate the rectangular sensor by 90 degrees so then the large size is oriented to the elevation and the short size to the lateral or horizontal position. This may be useful when it is required that a larger vertical FOV while the azimuthal is in any case covered by scanning. Then in order to scan a field of regard of 120 degrees, it will be necessary to stop at least 9 stops when no overlap is required. If some degrees of overlap between adjacent shots are required then the number of stops will increase accordingly. These are tradeoffs that should be taken in account when calculating the total scanning time consumed. The scanning time is also a function of the integration time in each stop and how many frames are grabbed in each stop. One, for example, may want to integrate several images in order to receive an average desired image. And if the integration time is less than the time defined by the frame rate then the frame rate may be raised in order to spend less time on each frame. For example, standard cameras 30 work at 25 or 30 Hertz, which means that the integration time of the frame is 20 milliseconds or 33 milliseconds correspondingly. If the capture is performed with an electronic shutter of 15 milliseconds length then 5 milliseconds of 18 milliseconds are spent without use. So the frame rate of the camera 30 can be increased in order to optimize the time used. This assumes that the time needed for the image-processing calculation can be neglected comparing to the integration time and the algorithm calculation time is not the bottle neck.

The common sensor formats may be ¼″, ⅓″ and ½″. There are larger and smaller formats and them also can be used. The definition of the sensor format should be part of the system tradeoffs since it can influence the performance from one hand and also the cost from another hand. Generally larger formats are more expensive but each pixel is also larger so it can collect much more photons, while actually smaller format are being made with higher and higher resolutions which means that the pixel areas are smaller and smaller.

The focal length used may be also larger and shorter than that presented in the example, for example, one can use a smaller focal length like 16 mm or 12 mm, then the Camera 30 FOV will be greater.

The common rectangular sensor arrays of light sources 10 are CCDs and CMOS detectors. These common sensors have standard resolution like VGA (640×480) and also better. The advantage of working with the lower VGA resolution is that the CPU time (processing time) used by the algorithm will be less than when working with higher resolutions allowing the scanning module 210 to scan faster.

These sensors are silicon technology devices and are suitable for applications working at spectral ranges less than 1100 nm in the NIR spectrum. Other technology sensors may be used if the higher spectral ranges are used, for example in order to detect eye reflections up to 1600 nm (SWIR wavelengths). These technologies are much more expensive than the common silicon technology. Also new technologies like germanium impurities implanted into silicon substrate may be used for SWIR wavelengths.

The illuminating light source 10 should be preferable in the NIR spectral range compatible with the lens optical filter 35. It may consist of a single light source 10 or a multiple light source 10 configuration. This light source 10 is preferably a LED NIR source but it can be any other source as well. The advantages of the use of a LED source are its higher electrical efficiency because of its spectral emittance in the specified spectral range. If, for example, an incandescent lamp is used then also a spectral filter 35 should be used to illuminate only in the required spectrum. A laser diode may also be used although it is less cost effective then using a LED. If the illumination is assembled with a single light source 10 then it should illuminate the same FOV like the camera 30 FOV, so every image point grabbed is illuminated. When using a multisource illumination, each light source 10 may illuminate a different portion if the image in the FOV of the camera 30 thus achieving the full FOV illumination. In general, using multisource illumination 10 allows to receive a better uniformity in the illumination. So as in the previous example, if the horizontal FOV is 14 degrees, then the illumination source 10 should be aligned in a mechanical bracket so they cover an illumination angle at least like the imaging FOV. It has to cover also the vertical 11 degrees FOV.

Both the camera 30 and illumination source 10 should be assembled in a mechanical bracket so it can be rotated in order to achieve the scanning movement. If the illumination consists of multiple light sources 10 then the bracket shall be prepared so the right orientation of each light sums into the overall vertical and horizontal FOV. The overall panoramic lateral field of regard (the 120 degrees) is thus captured by the scanning operation.

The mechanical bracket with the camera 30 and the light source 10 on it are joined to a motor. Different kinds of motors may be used, like a step motor, Micro-Electro-Mechanical Systems (MEM's) technology, or any other kind of available motor in the industry. The motor is operated with the use of an electronics driver which may be controlled by a microprocessor such as an 8051 microprocessor.

The synchronized operation of the motor, the camera 30 shutter and the illumination timing is controlled with the help of a microprocessor 90. Although in a synchronizing method of operation it is assumed that the illumination is pulsed, it is possible to operate the scanning at a Direct Current (DC) level of operation, i.e the light source 10 is illuminating all the time with no pulses while the camera 30 grabs the images without synchronizing. The motor is driven to move from one stop to another and after a predefined delay allowing the camera 30 enough time for grabbing an image, the motor moves the camera 30 to its next grabbing position.

Another possible operation of the scanning is by using a different motor, for example, a DC motor, where the camera 30 is constantly moving, and every time the camera 30 reaches the right position the shutter is opened. In this mode it is important that the shutter is opened for a very short time so the image is not blurred by the scanning movement. The shutter time can be derived from the scanning velocity in such a way that the shutter time should be less than the time it takes the camera to move the angle subtended by a single pixel. For example, if the horizontal pixel size is 0.01 millimeter (mm), then if the velocity is 10 degrees/second then the shutter should be less than 2.3 milliseconds, this assumes the same focal length than before 25 mm.

The panoramic lateral field of regard is arbitrary and limited by the mechanics so it can be designed according to the application needs. In principle it can be 360 degrees, but in that case special wiring methods should be implemented.

The more common field of regard is up to 180 degrees, so the motor can be run back and forth and standard wiring should be applied with common methods like those used with printing machines

The field of view is defined by two parameters the sensor format size and the lens focal length. Using a large sensor allows to use larger focal length in order to keep the same FOV as a small sensor format with a lens which has a shorter focal length.

One additional advantage of the scanning method is from the safety point of view. Since the field of regard is illuminated only when the scanning module is aiming to a certain specific direction, then the audience 20 located at that direction is exposed only on those specific moments. Otherwise if no scanning method is used and the whole field of regard is viewed as a single field of view then the illumination power should be much greater in order to illuminate simultaneously the whole 180 degrees and every person in the audience 20 is exposed all the time. Using a scanning method of the invention, the exposure is reduced to only when the camera 30 is aiming at a specific position. On the other hand, since the light detector 30 sensor is a similar (in both scanning and static methods) then each pixel in the sensor looks at a much smaller area in the object thus receiving much less light. So in order to be able to detect eyes efficiently, higher illumination levels are needed and these levels will either be elevated above the safety limit in order to reach to the required levels for detection or limited to the allowed safety levels so the detection performance is degrated.

The electronic drivers for scanning, for illumination and for synchronization are similar to those described above.

In another embodiment of the present invention, the optics of the camera 30 may include in addition to the spectral filter 35 and the lens also polarizing means that when assembled correctly they may eliminated unwanted reflections which disturbs the image causing better detection algorithms to discriminate the eyes from the whole picture. One linear polarizer is located in front of the illumination source 10 with the polarization axis vertical (for example) and another linear polarizer is located in front of the camera 30 lens with its polarizing axis horizontal (if the illumination 10 polarizer was at horizontal orientation, then the camera 30 polarizer would be at a vertical orientation). Then reflections from the cornea and from spectacles and from any other shiny surface in the room will be eliminated since its reflection preserves the polarization orientation. Since the eyes reflection from the retina only partially preserves polarization then it will be still possible to detect the eyes.

A different approach to the above can be done if the illumination source 10 is already linearly polarized, then only one polarizer is needed in front of the camera 30 lens, and its orientation should be orthogonal to the illumination polarization orientation.

Other methods for eliminated parasitic reflections from surfaces in the image are algorithmic methods that may be based on a single non polarized image, a polarized image or simple image subtraction between to images grabbed under slightly different illumination conditions.

The algorithm methods that are used on non manipulated images look for special reflections like “nice” circular” stains or blobs in the picture with high grey level intensities. These blobs are then compared to the average value of their surrounding image in order to eliminate “un-normal” picture areas.

Other algorithms may be based on manipulated images based on the subtraction of two imaged exposed under slightly different illumination conditions. In this case, since the bright pupil reflections as explained above is more intense when the light source 10 and the camera 30 are coaxial, one can purposely illuminate in a non coaxial way and when compare to the coaxial way of illumination then the most significant difference between these two pictures will be those part of the picture which are sensitive to the coaxial/non coaxial illumination. All other parts which are not sensitive will appear similar and by subtracting the non coaxial image from the coaxial image will leave only the eyes detectable (“above the water”). Preprocessing may be required on each image before the subtraction in order to remove minor special noise.

In this method it is important that the two pictures (the coaxial and the non coaxial) should be grabbed as close (in time sense) as possible since any arbitrary movement will be enhanced by the subtraction. On the other hand it is not acceptable to ask the audience 20 not to move. It is thus sensible to use if the exposure time is short enough to use higher frame rates, so the time interval between the frames is limited by the shutter.

Another method of image subtraction is to take advantage of eyelid blinking. By grabbing many consecutive frames once a blinking of the eyelid occurs then by subtracting the blinked image from the regular image the only difference between these images will be the appearance of the bright pupil of the non blinked image so any other feature in the image will disappear leaving only the eyes in the scene.

When dealing with images of persons with spectacles, it may occur from time to time that one of the bright pupils of the person is hidden behind a spectacle circular reflection from the spectacle. This may happen for direct and straight gaze of a person wearing glasses into the camera. This kind of disturbances may be avoided by placing the device quite aside from the TV set so there is no chance that the person will look directly to the camera.

Scanning can also be helpful in such cases when the scan is planned in such a way that image overlapping is obtained in adjacent stops of the scanning motor. When image overlap occurs then the person appears in more than one picture. More than that, the person will appear in different locations of the picture, and since in one picture the person may appear looking directly to the camera 30 in one stop, once the camera 30 with the motor moves to the next stop then with the illumination source 10 moved aside together with the camera 30, then a different reflection angular situation is formed. Thus if in one picture the bright pupil was hidden behind a spectacle reflection, then in the overlapped image it will be expected that the bright pupil will appear again.

Accurately estimating the number of people in an audience 20 can have great commercial implications for different applications such as estimating the popularity of television programs, how many people watch an advertisement, how many people enter a shopping mall, how many people visited an exposition or a conference, how many people entered a commercial location etc.

In one embodiment of the present invention, the metering system further includes applications to detect the content of the television program the audience 20 is watching. For example, the system of the invention can connect to a television set-top box receiving TV channels via satellite, cable or the Internet in order to determine which channel is broadcast on the television set at each moment. Data received directly or indirectly from the TV service operator (typically cable or satellite nowadays, and through the Internet in the future) lists at every given moment the content broadcast on each channel. The content is typically looked at as being either a commercial advertisement or a television program. The detection applications can be implemented in a combination of hardware and/or software.

In one embodiment of the present invention, the price of commercial advertisement is determined in relation to the audience 20 reports provided by the invention. The more people watch an advertisement the higher it can be priced. Advertisements can thus be priced in real-time according to the number of people actually watching at a given moment. Alternatively, the audience 20 actually measured can be looked at as a sample representing the real number of people watching at a given moment.

In a further embodiment of the present invention, each television (or household) receives individual, personalized commercial advertisements according to measured audience 20 ratings for each specific television (or household) and according to additional parameters such as socio-demographic data, personal preferences, previously recorded TV watching habits etc. The invention thus allows targeting of custom advertisements for each television set and/or household.

In yet a further embodiment of the present invention, each household is allocated a group of advertisements. Each advertisement of that group is only displayed when an audience 20 is identified as watching the television set. In this way, it can be guaranteed to the advertiser that the advertisement has actually been seen by an audience 20 as opposed to cases where people take a bathroom break when the advertisements begin or they change channels while waiting for the program to resume.

More and more television sets are adapted to displaying both television programs and content from the Internet. In the case that people are watching television and sharing an Internet connection through the same TV set, sometimes the audience 20 is interested to know if another person such as a friend or family member is also watching the same program. Instant Messaging (IM) type applications can signal when a person is online or not. The problem is that many times a user can log on and then actually leave the room without logging off.

In yet another embodiment of the present invention, the metering device 5 of the invention is installed on two television sets with external communication lines 100 such as the Internet, wherein a first person in front of one television set can be notified if a second person is in front of a second television set and the two people can communicate between themselves. Examples of communication lines 100 include text (email, chat, IM), voice, video or any combination thereof.

In yet another embodiment of the present invention, the system of the invention is used for measuring the Pupillary Distance. Pupillary Distance is the distance from the center of the pupil (black circle) in one eye to the center of the pupil in the other eye. This measurement is used by optometricians to accurately center the lenses in the spectacles' frame. Typical adult's Pupillry Distance measurements (PDs) are from 54 to 66 millimeter. Typical children's Pupillary Distance measurements are from 41 to 55 millimeter. The reflection from the retina is higher in case of young people and lower for older people. It is obvious that when the light detector 30 is composed of a single light detector 30 or an array with a low number of detectors then it is not possible to measure the distance between the eyes (PD) and it is impossible to separate eyes. Instead, the counting is done by detecting the accumulated energy that each eye contributes in comparison with the contribution from the background signal.

Using the PD information may allow defining the exact person that watches the TV at a specific household assuming that every person in the family has a different PD. In general, it is possible to differentiate between adults and children in the audience 20 assuming they sit at the same distance. If the system detects children watching some adult programs, for example, these programs can then be blocked by the metering device 5. PD can also be used to estimate the age of each viewer, and if necessary adapt the program displayed to the viewer's age. For example, advertising can be adapted for either adults or children or specific content can be restricted if there are children in the audience 20. The amount of reflected light received by each eye can also be used in order to estimate the age of each viewer in audience 20.

In another embodiment of the present invention, when the exact number of eyeballs (or eyes counted) is not essential then it is also possible to detect the presence of an audience 20 in front of the television by capturing the reflection from uncovered body skin after comparing it to the background scene. The system may learn the reflection from the background, for example, by calibration of the system during the installation or by an auto-calibration method that tracks the changes in the reflected light. For example, a single light detector 30 is used as the light detector 30 and during installation a technician calibrates a threshold potentiometer that measures the background level of the reflection according to that level the system recognize when a person is present according to the change in that predefined signal level. According to the changes it is possible to estimate how many people are in front of the television.

Regarding outdoors advertisements, the metering system may be located adjacent to the advertising platform or billboards so it can “see” the audience 20 that is watching the advertisement. If it is possible, it can also be mounted behind the billboard and “look” at the people in front of the advertisement through an opening in the billing board.

The system of the invention can be used to measure the length of time that the eyes are set on the outdoor advertisement as well as the number of people who have seen the advertisement regardless if they watched it enough time to capture the message of the advertisement.

The system of the invention can be installed or integrated, for example, in a set-top box or in the TV panel itself or in a “media center” or in any place that can be seen by the audience.

Many television sets remain active even though nobody is in front of the television. It is possible to use the metering system of the invention to determine if nobody is watching the television, and then turn the television off after a predetermined period of time thus saving electricity and increasing the life of the screen.

In another aspect, the present invention relates to an interactive computer system for interacting with a user, comprising:
(i) one or more light sources 10 directed in the direction of said user;
(ii) one or more light detectors 30 for detecting reflections of said one or more light sources 10 forming one or more images representing said user's eyes;
(iii) a processing unit for analyzing said one or more images received on said one or more light detectors 30 to identify the position of said user's eyes on said one or more images; and
(iv) applications for modifying the content displayed on said interactive system based on the analysis performed on said one or more images.

For example, this interactive system can be used to scroll a page on a computer screen up or down based on the position of the user's eyes. Such an interactive system is particularly adapted for users at a distance of over 60 centimeters from the system.

Although the invention has been described in detail, nevertheless changes and modifications, which do not depart from the teachings of the present invention, will be evident to those skilled in the art. Such changes and modifications are deemed to come within the purview of the present invention and the appended claims.

1. A metering system for measuring an audience, said system comprising:
(i) one or more light sources directed in the direction of said audience;
(ii) one or more light detectors for detecting reflections of said one or more light sources from said audience to form an image representing eyes in said audience;
(iii) a scanning module to direct said one or more light sources and said one or more light detectors at narrow portions of said audience at a time;
(iv) a scanning controller for driving said scanning module; and
(v) a processing unit for analyzing the images received on said one or more light detectors to form an image representing said audience eyes and to identify and count the number of eyes on said image.

2. A metering system according to claim 1, further containing a communications line for communicating the analysis of the image received to a remote facility.

3. A metering system according to claim 1, wherein eyes are identified by detecting reflected light from the retina or the cornea or both.

4. A metering system according to claim 1, wherein said one or more light sources or said one or more light detectors comprise a spectrally narrow bandwidth or a spectral filter, said spectral filter comprising: a band pass filter, band stop filter, interference filter, short wave filter, long wave filter, Acousto-optic Tunable filter (AOTF) or any mechanical, electrical or electro physical mechanism that can cause a spectral modification of outgoing or incoming light.

5. A metering system according to claim 4, wherein the wavelength between the one or more light sources and the one or more light detectors are made to correspond and the spectral filter of the one or more light detectors is of a similar, narrower or greater wavelength than the spectral filter of the one or more light sources in such a way that optimal performance is achieved.

6. A metering system according to claim 1, wherein said one or more light detectors comprise a light detector, photodiode, an avalanche photodiode, an array of detectors, Charge Coupled Device (CCD) camera, Complementary Metal Oxide Semiconductor (CMOS) array or an intensified camera.

7. A metering system according to claim 1, wherein said audience is in front of a television set watching a television program, said metering system further comprising applications for detecting or changing or detecting and changing the program said audience is watching on said television set.

8. A metering system according to claim 7, wherein said content is an advertisement.

9. A metering system according to claim 8, wherein the choice of advertisement to display for said audience is determined according to the measured audience; or said advertisement is priced according to the audience measured; or both.

10. A metering system according to claim 8, wherein each household is allocated a group of advertisements such that each advertisement is only displayed if an audience is identified before said television set.

11. A metering system according to claim 1, incorporated into a television set-top box or into a television set.

12. A metering system according to claim 1, wherein the age of each viewer is estimated by analyzing the distance between the eyes or the amount of reflected light received by each eye or both.

13. A metering system according to claim 12, wherein depending on the estimated age of the audience members selected advertisement is displayed to said audience; or inappropriate content is blocked on a television set or on an Internet site if at least one audience member is a child; or both.

14. A metering system according to claim 1, wherein at least one of said one or more light sources and said one or more light detectors operate in the following ranges:
(i) 200 nm to 1600 nm;
(ii) 700 nm to 940 nm;
(iii) 1050 nm to 1150 nm; or
(iv) 1300 nm to 1450 nm range.

15. A metering system according to claim 1, wherein said one or more light detectors can operate in a plurality of exposure times synchronized with the pulse of said one or more light detectors.

16. A metering system according to claim 1, wherein said audience is in front of an outdoor billboard and said processing unit measures the length of time an eye is looking at said outdoor billboard.

17. A metering system according to claim 1, wherein the screen of a television set is turned off after a predetermined period of time if no audience is watching said television set.

18. A metering system according to claim 1, wherein the presence of an audience member in front of a television set is communicated to one or more predefined audience members in front of other television sets.

19. A method for counting an audience, said method comprising the steps of:
(i) directing one or more light sources in the direction of said audience;
(ii) detecting reflections of said one or more light sources by one or more light detectors in order to form an image representing eyes in said audience;
(iii) scanning the audience by directing said one or more light sources and said one or more light detectors at narrow portions of said audience at a time; and
(iv) analyzing images received on said one or more light detectors to form an image representing said audience eyes and to identify and count the number of eyes on said image.

20. A method according to claim 19, wherein eyes are identified by detecting reflected light from the retina or cornea or both.

21. A method according to claim 19, wherein said one or more light sources or said one or more light detectors comprise a spectrally narrow bandwidth or a spectral filter, said spectral filter comprising: a band pass filter, band stop filter, interference filter, short wave filter, long wave filter, Acousto-optic Tunable filter (AOTF) or any mechanical, electrical or electro physical mechanism that can cause a spectral modification of outgoing or incoming light.

22. A method according to claim 19, wherein said one or more light detectors comprise a light detector, photodiode, an avalanche photodiode, an array of detectors, Charge Coupled Device (CCD) camera, Complementary Metal Oxide Semiconductor (CMOS) array or an intensified camera.

23. A method according to claim 19, wherein said audience is in front of a television set watching a television program, said method further comprising applications for detecting or changing or detecting and changing the program said audience is watching on said television set.

24. A method according to claim 23, further including applications for detecting or changing or detecting and changing the content of said television program said audience is watching.

25. A method according to claim 24, wherein said content is an advertisement and the choice of advertisement to display for said audience is determined according to the measured audience.

26. A method according to claim 19, wherein the age of each viewer is estimated by analyzing the distance between the eyes or the amount of reflected light received by each eye or both.

27. A method according to claim 19, wherein at least one of said one or more light sources and said one or more light detectors operate in the following ranges:
(i) 200 nm to 1600 nm;
(ii) 700 nm to 940 nm;
(iii) 1050 nm to 1150 nm; or
(iv) 1300 nm to 1450 nm range.

28. An advertising method for sending commercial advertisements to an audience in front of a television set, the method comprising the steps of:
(i) detecting the presence of at least one viewer in front of said television set; and
(ii) sending an advertisement to said television set only when said at least one viewer is detected.

29. An advertising method according to claim 28, wherein the presence of said at least one viewer is detected by one or more of the following methods: redeye detector, skin reflection detection, human shape analysis, face detection, voice detection, and/or volume detection.
